(19) United States
(12) Patent Application Publication
(10) Pub. No.: US 2011/0025187 A1
(43) Pub. Date: Feb. 3, 2011

(54) LOW-PRESSURE GAS-DISCHARGE LAMP FOR INFLUENCING THE ENDOGENOUS MELATONIN BALANCE

(75) Inventors: Walter Tews, Greifswald (DE); Gundula Roth, Levenhagen (DE); Juergen Meltke, Brand-Erbisdorf (DE); Hans Juergen Walther, Brand-Erbisdorf (DE)

Correspondence Address: MILLEN, WHITE, ZELANO & BRANIGAN, P.C., 2200 CLARENDON BLVD., SUITE 1400, ARLINGTON, VA, 22201, US

(73) Assignees: MERCK PATENT GESELLSCHAFT MIT BESCHRANKTER HAFTUNG, DARMSTADT (DE); NARVA LICHTQUEQUELLEN GMBH + CO. KG, BRAND-ERBISDORF (DE)

(21) Appl. No.: 12/936,766

(22) PCT Filed: Mar. 13, 2009
(86) PCT No.: PCT/EP2009/001821

§ 371 Date: Oct. 7, 2010

(30) Foreign Application Priority Data
Apr. 8, 2008 (DE) 10 2008 017 606.0

(51) Int. Cl. H01J 1/62

(52) U.S. Cl. 313/487; 313/485

(57) ABSTRACT

The invention relates to a low-pressure gas-discharge lamp which, with its light in the red spectral region, influences the biological circadian rhythm by controlling melatonin secretion. The tubular glass discharge vessel, which can also be in the shape of a double helix, is filled with a noble gas or noble-gas mixture and mercury. Electrodes for the supply of energy are arranged at both ends of the discharge vessel. The discharge vessel is multicoated on the inside by phosphor layers applied one after the other. The first phosphor layer located on the glass surface consists of phosphor which is excited both by ultraviolet mercury radiation between 180 nm and 400 nm and also by the blue radiation between 400 nm and 490 nm emitted by the mercury discharge, and by the visible radiation emitted by the second or further phosphor layers between 400 nm and 550 nm, where visible light having emission maxima in the region between 500 nm and 650 nm is generated. In combination with light sources for melatonin suppression, the low-pressure gas-discharge lamp is, with its warm light, particularly suitable for stimulation of the quasi-circadian rhythm in an individual in the absence of external conditions, such as sunlight. Owing to its good colour reproduction and high energy efficiency, it meets all necessary requirements of a light source for illumination tasks and is thus also suitable for general lighting.

The invention relates to a low-pressure gas-discharge lamp for influencing the endogenous melatonin balance, which is preferably suitable for biological/medical applications. The aim is for the biological circadian rhythm to be influenced specifically by means of the light source according to the invention by controlling melatonin secretion.

### PRIOR ART

It is known from medicine that virtually all human processes are subject to biological action functions. One of these is the circadian action function, which influences melatonin secretion. Melatonin is a sleep hormone which is produced from serotonin and excreted by the pinealocytes in the pineal gland (epiphysis), a part of the interbrain, and controls the day/night rhythm of the human body. In chemical terms, it is an alkaloid having a tryptamine structure.

Morita, Tekeshi and Tokura: The influence of different wavelengths of light on human biological rhythms, in Appl Human Sci, 17 (3): 91-96, 1998, describes the relationship between the quality of light and the human biological rhythm. It has been established that the behaviour of the core temperature and the change in melatonin secretion changes as a function of the light wavelength. While light having a long wavelength, such as light having a low colour temperature, red light, has no effects on the human biological rhythm, green and blue light, which has a medium-short wavelength and high colour temperature, exhibited, by contrast, greater effects. It is concluded from the relationship between the excitation of the photoreceptors in the human eye and the inhibition of the core temperature and of melatonin that the photoreceptor, after reception of the light signal, determines the biological rhythm by means of the activity of melatonin secretion. It has been observed that a higher light intensity is required in the morning than in the evening in order to initiate inhibition of melatonin secretion. The influence on the human biological rhythm throughout the day is due to the photoreceptors of the eyes, which receive the signals for melatonin secretion.

The living and working environment is illuminated in the evening and during the night by light having a low colour temperature and from early morning to evening by light having a high colour temperature.

The light having a wavelength between 400 nm and 500 nm and a wavelength maximum at 450 nm enables melatonin suppression to be increased and the performance capability and wellbeing of the individual to be increased. When light disappears at darkness, melatonin suppression drops and the excreted melatonin initiates the sleep phase.

After the correlations between melatonin suppression and wellbeing due to the influence of light in the blue wavelength region became known, low-pressure gas-discharge lamps for general lighting which have an increased blue content were developed. In general lighting, the colour temperature is often used to differentiate between various light colours. The increase in the blue content accordingly inevitably results in lamps having higher colour temperatures.

EP 1735405 A1 describes a low-pressure gas-discharge lamp whose phosphors are composed of a europium-doped yttrium phosphor which emits in the red wavelength region, a cerium- and terbium-doped lanthanum phosphate phosphor which emits in the green wavelength region, a europium-doped barium magnesium aluminate phosphor which emits in the blue wavelength region and a manganese- and europium-doped manganese strontium barium magnesium aluminate phosphor which emits in the blue wavelength region. The low-pressure gas-discharge lamp meets all requirements for general lighting and preferably achieves a colour temperature of 8000 K. It is furthermore stated that lamps having colour temperatures up to 20,000 K are conceivable. This development direction is followed from the point of view of increasing the blue content in general lighting by means of low-pressure gas-discharge lamps in order to influence the circadian rhythm, increase melatonin suppression and thus increase human wellbeing and performance capability.

Another use of light for influencing the circadian rhythm is described in DE 10 2005 059 518 A1 for increasing the melatonin content in the milk from mammals. In accordance with the circadian rhythm, melatonin secretion is also greatest in the night hours in mammals. Since it is difficult to milk animals in darkness, sodium vapour lamps or preferably red-emitting LED lamps are used as light source in the cited invention in order to ensure freedom from blue. The disadvantage in the use of narrow-band lamps of this type consists in the absence of good colour reproduction, which is important for visual tasks.

US 20050179392 A1 discloses a low-pressure gas-discharge lamp which is likewise intended for influencing melatonin secretion. It has a discharge vessel provided with an inert gas mixture and mercury. The discharge vessel contains two discharge chambers arranged symmetrically to one another and connected to one another. The first and second discharge chambers are each fitted with an electrode and a luminescent layer. The phosphor in the first discharge chamber emits light in a first region of the electromagnetic spectrum from 100 nm to 1000 nm, and the phosphor in the second discharge chamber emits light in a second region of the electromagnetic spectrum from 100 nm to 1000 nm, where the emission spectrum of the two phosphors differs. The low-pressure gas-discharge lamp contains two current conductors per discharge chamber for receiving the direct-current supply. The lamp has a variable colour temperature and influences the human biological rhythm. The light-current level generated is independent of the temperature. The lamp is preferably employed for shift work, in first-aid stations in hospitals, etc.

EP 1886708 A1 describes a lighting assembly having a melatonin-protecting action. The lighting assembly is activated by means of three phosphor lamps and is able to generate light in different spectral compositions or colour temperatures, where, on activation, the spectral composition of the light generated is freely selectable depending on a prespecified time scheme. In a predefined time period, in particular at night, a melatonin light is generated which is of such a spectral composition and intensity that it at least very substantially does not inhibit excretion of the hormone melatonin at night in an individual. With reference to the spectral composition of the melatonin light, it is provided that the portion of the blue spectrum below the wavelength threshold value is between 480 nm and 600 nm, preferably between about 500 nm and 560 nm, or that the melatonin light has a colour temperature which is lower than, for example, 1500 K. In this way, it is prevented that, in the case of artificial light at night, natural melatonin secretion by an individual exposed to this light is inhibited in an undesired manner. According to Christoph Schierz: Der Mensch im farbigen Licht [People in Coloured Light], in Licht 2006: 17th Light Community Congress of the Swiss Light Society and the Light Societies of Germany, Austria and the Netherlands, 10 to 13 Sep. 2006, Bern, the spectral sensitivity of melatonin suppression vis-à-vis the spectral brightness sensitivity function V(λ) appears to be shifted into the blue-appearing region of the spectrum. It is shown that a similar spectral sensitivity must also apply to the stabilisation of the biological clock over time and to the increase in the subjective and physiological degree of alertness. The most recent scientific knowledge on the biological effect of light and colour is that blue stimulates and activates, red has no or even an inhibitory effect in this respect.

The known prior art shows that knowledge of the circadian rhythm has only resulted in the development of low-pressure gas-discharge lamps having relatively high colour temperatures and a relatively high blue content with simultaneous safeguarding of visual tasks and compliance with current regulations on energy efficiency.

### Object

The object of the invention is to provide a light source with which the circadian rhythm can be influenced specifically by melatonin secretion. In combination with the light sources for melatonin suppression, the light source should be particularly suitable for stimulation of a quasi-circadian rhythm in the absence of external conditions, such as sunlight. At the same time, the low-pressure gas-discharge lamp should meet all necessary requirements of a light source for illumination tasks through good colour reproduction and high energy efficiency and should thus also be suitable for use in general lighting.

The low-pressure gas-discharge lamp according to the invention should at the same time meet the present requirements for visual tasks which are made of light sources of this type. These include high light flux, good colour reproduction and compliance with current regulations on energy efficiency.

### DESCRIPTION OF THE INVENTION

The object is achieved by the production of a low-pressure gas-discharge lamp whose blue content in the spectral energy distribution in the wavelength range between 400 nm and 500 nm is extremely low and are below the threshold value for melatonin suppression.

The low-pressure gas-discharge lamp according to the invention for influencing the endogenous melatonin balance consists of the known glass tube. The glass discharge vessel may in accordance with the invention also have the shape of a double helix. The discharge vessel may also consist of U shapes connected together or of short tube sections joined together via connecting channels.

In one form of the low-pressure gas-discharge lamp, the discharge tube is shaped by folding, deformation, welding or joining, in which the outer dimensions of the discharge vessel are only a fraction of the extended length of the discharge vessel.

The discharge vessel of the low-pressure gas-discharge lamp is, in a known manner, filled with a noble gas or noble-gas mixture and mercury and has at both ends electrodes for the supply of energy. The inside of the discharge vessel is multicoated with phosphor.

The low-pressure gas-discharge lamp according to the invention has phosphor layers applied one after the other to the glass surface of the inside of the discharge vessel. The first phosphor layer, which is applied as base layer to the glass surface, consists of a phosphor which is excited both by ultraviolet mercury radiation between 180 nm and 400 nm and also by the blue radiation between 400 nm and 490 nm emitted by the mercury discharge, and by the visible radiation emitted by the second or further phosphor layers between 400 nm and 550 nm, where visible light having emission maxima in the region between 500 nm and 650 nm is generated and the second or further phosphor layers, which serve as top layer, consist of one or more narrowband-emitting phosphors which generate visible light.

The first phosphor layer applied directly to the glass surface consists of a phosphor or phosphor mixture from the group of the silicates or aluminates and is preferably doped with europium or cerium. This phosphor belongs to the group of the alkaline-earth metal orthosilicates and/or alkaline-earth metal oxyorthosilicates, activated by divalent europium, and the ions may contain further rare-earth metals as well as manganese, zinc and magnesium.

The phosphor comprising an Eu-activated alkaline-earth metal orthosilicate has the formula (Ba, Sr, Ca)₂SiO₄:Eu and the name BOSE.

The phosphor comprising an Eu-activated alkaline-earth metal oxyorthosilicate has the formula (Ba, Sr, Ca)₃SiO₅:Eu and the name SOOS.

The aluminate phosphor from the group of the garnets has the formula Y₃Al₅O₁₂:Ce and the name YAG.

The phosphor of the first phosphor layer on the inside of the discharge vessel of the low-pressure gas-discharge lamp has an emission maximum in the spectral region between 560 nm and 650 nm.

The second phosphor layer consists of one or more narrowband-emitting phosphors which emit in blue/turquoise at an emission maximum between 440 nm and 500 nm and/or in green at an emission maximum between 535 nm and 555 nm and/or in red at an emission maximum between 605 nm and 650 nm.

The red-emitting phosphor is preferably an yttrium oxide:Eu and/or yttrium vanadate:Eu and/or magnesium fluorogermanate:Mn. The green-emitting phosphor is a lanthanum phosphate:Ce,Tb and/or magnesium aluminate:Ce,Tb. The blue/turquoise-emitting phosphor is a barium magnesium aluminate:Eu and/or strontium calcium barium phosphate:Eu and/or strontium aluminate:Eu and/or strontium chlorophosphate:Eu.

The proportion of blue-emitting phosphor in the mixture is between 0% and 10%.

By means of the invention, it is possible, in combination with the existing low-pressure gas-discharge lamps having a high colour temperature and correspondingly high blue content which result in melatonin suppression, to influence the sleep phase and thus to stimulate the entire circadian rhythm of humans.

In low-pressure gas-discharge lamps of conventional design, the blue content in the visible spectrum results from two emission sources of different types: the emission spectrum of the phosphors and the emission of the mercury lines of the low-pressure gas-discharge itself at 405 nm and 436 nm. The emission line at 436 nm is, at 47.5%, the strongest in the energy distribution of the mercury lines in the visible spectrum and can be detected in a known manner in any low-pressure gas-discharge lamp.

For melatonin secretion using low-pressure gas-discharge lamps, the mercury emission line at 436 nm means that it is not sufficient to omit phosphors having an emission in the range from 400 nm to 500 nm.

The purpose of the low-pressure gas-discharge lamp according to the invention for melatonin secretion can only be achieved by absorption of the mercury emission line at 405 nm and especially at 436 nm and is carried out with a blue-absorbent phosphor.

The blue-absorbent phosphor has an excitation spectrum between 180 nm and 550 nm and generates visible light having an emission maximum in the range between 500 nm and 650 nm.

However, the spectral distribution and stability of the blue-absorbent phosphor is not sufficient to meet the requirement for a low-pressure gas-discharge lamp having a good visual-value function. The first phosphor layer, which consists of the blue-absorbent phosphor, is thus coated with a second phosphor layer comprising the mixture of a red- and green-emitting narrowband phosphor. The absence of the blue content in the spectral distribution of the visible spectrum means that the colour temperature is only 1000 K to 3000 K, preferably 2000 K.

Optimisation of the emission maximum of the blue-absorbent phosphor in the base layer, the composition in the phosphor mixture of the top layer and the layer thickness of the two layers gives the low-pressure gas-discharge lamp according to the invention the properties which are required to achieve the visual tasks.

### Working Example

The low-pressure gas-discharge lamp according to the invention will be explained in greater detail with reference to a working example.

Table 1 shows the technical light parameters of the two LT 18 W low-pressure gas-discharge lamps according to the invention compared with two conventional LT 18 W low-pressure gas-discharge lamps.

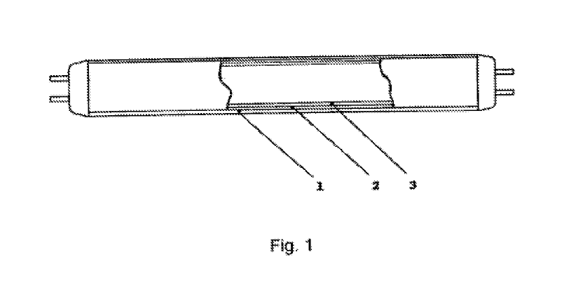

The low-pressure gas-discharge lamp according to the invention for influencing the endogenous melatonin balance has, according to FIG. 1, the glass discharge vessel 1 having the shape of a straight tube, which has at both ends electrodes for the supply of energy and is filled with a noble gas or noble-gas mixture and mercury. Phosphor layer 2 as base layer and, on top of the latter, phosphor layer 3 as top layer are applied one after the other to the inner glass surface of the discharge vessel.

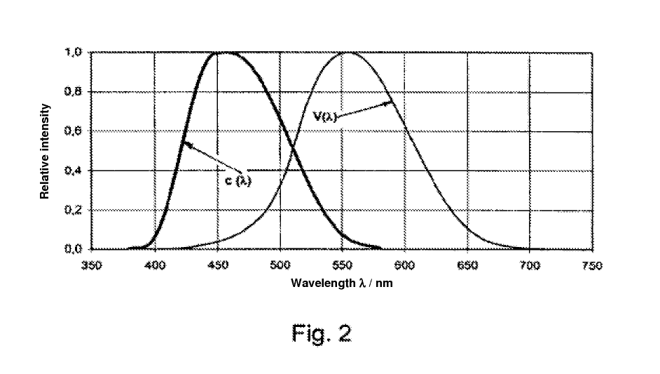

FIG. 2 shows the circadian action function c(λ) and the spectral brightness sensitivity curve V(λ) of the LT 18 W low-pressure gas-discharge lamp according to the invention.

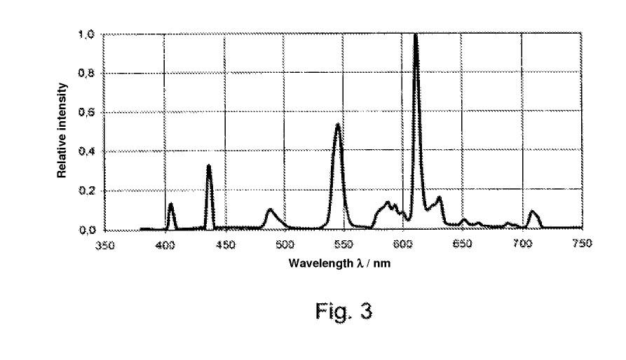

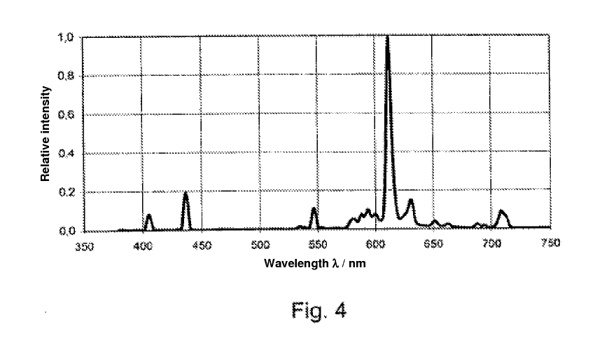

The spectrum of the known LT 18 W three-band low-pressure gas-discharge lamp having the warm-white comfort light colour is shown in FIG. 3. The spectrum of the known LT 18 W low-pressure gas-discharge lamp having the red light colour is shown in FIG. 4.

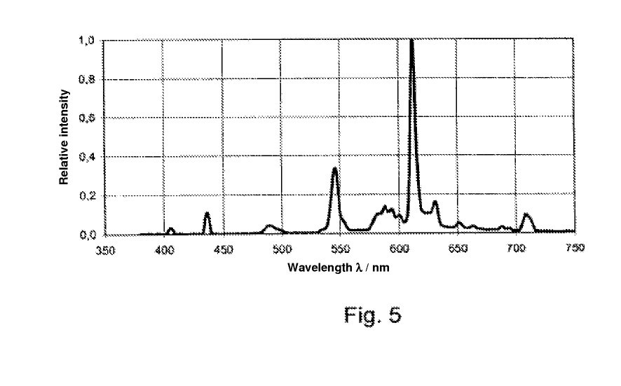

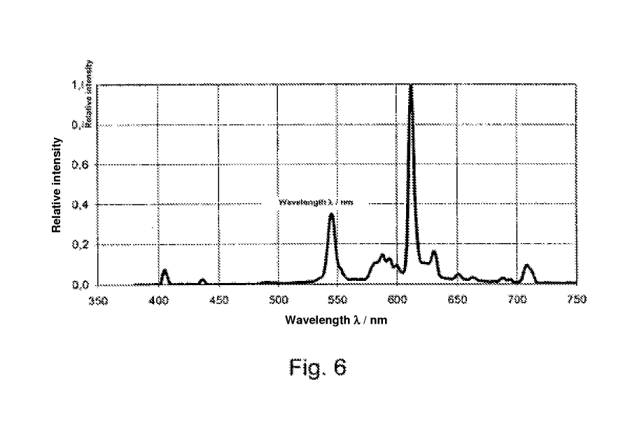

For comparison, FIG. 5 shows the spectrum of the LT 18 W low-pressure gas-discharge lamp according to the invention comprising the phosphor (Ba, Sr, Ca) orthosilicate:Eu, which serves as base layer and is known as BSCOSE (F612), and FIG. 6 shows the spectrum of the LT 18 W low-pressure gas-discharge lamp according to the invention comprising the phosphor YAG as base layer.

In both working examples, LT 18 W low-pressure gas-discharge lamps having a standard length of 590 mm and a glass tube diameter of 26 mm with a lamp power of 18 W are described.

### Example 1

An Eu-activated alkaline-earth metal orthosilicate is used as blue-absorbent phosphor in the discharge vessel of the LT 18 W low-pressure gas-discharge lamp.

The base layer is produced by coating the blue-absorbent phosphor onto the inside of the glass flask as suspension, with hydroxyethylcellulose as binder and dimethylolurea as crosslinking agent. The layer thickness of the base layer is in accordance with the invention between 0.2 mg/cm² and 2.0 mg/cm², preferably 1.25 mg/cm².

The coating used for the second layer as top layer is a phosphor mixture comprising the narrowband red-emitting phosphor yttrium oxide:Eu (YOX) and the narrowband green-emitting phosphor lanthanum phosphate:Ce,Tb (LAP) as suspension with polyethylene oxide as binder. The phosphor mixture consists of 60% to 99% of the phosphor YOX and 1% to 40% of the phosphor LAP, preferably 85% of the phosphor YOX and 15% of the phosphor LAP.

The layer thickness of the top layer is in accordance with the invention between 1.0 mg/cm² and 6.0 mg/cm², preferably 3.25 mg/cm².

The coated glass flask is fired and then subjected to conventional manufacturing technology for low-pressure gas-discharge lamps.

The LT 18 W low-pressure gas-discharge lamp produced with the BSCOSE phosphor F612 as base layer has the following technical light parameters:

Light flux: 1341 lm
Lamp power: 18.0 W
Colour temperature: 1995 K
Colour reproduction: 81.3.

### Example 2

The coating of the glass flask of the LT 18 W low-pressure gas-discharge lamp is carried out with the phosphor YAG as base layer. The coating of the top layer is carried out analogously to Example 1.

The following technical light parameters are achieved with the LT 18 W low-pressure gas-discharge lamp produced in this way:

Light flux: 1408 lm
Lamp power: 18.0 W
Colour temperature: 1995 K
Colour reproduction: 81.3.

The light flux is evaluated in accordance with the spectral brightness sensitivity curve V(λ), as shown in FIG. 2, with a wavelength maximum of 550 nm.

In order to characterise the melatonin secretion of the low-pressure gas-discharge lamp according to the invention, use is made of the circadian effect factor, which is calculated from the ratio of the integral products of irradiation strength and circadian action function c(λ) and irradiation strength and spectral brightness sensitivity curve V(λ).

Table 1 shows the circadian effect factor of the LT 18 W low-pressure gas-discharge lamps according to the invention from Examples 1 and 2 compared with conventional low-pressure gas-discharge lamps of the same lamp power in the warm-white comfort and red light colours. At the same time, Table 1 shows the technical light parameters of the four LT 18 W low-pressure gas-discharge lamps compared with one another.

TABLE 1

| LT 18 W low-pressure | Circadian | | | Colour |
|---|---|---|---|---|
| gas-discharge lamp | effect | Colour | Light | reproduction |
| with: | factor | temperature | flux | index |
| Warm-white comfort | 0.301 | 2642 K | 1344 lm | 83.7 |
| light colour | | | | |
| Red light colour | 0.178 | 1250 K | 955 lm | 49.2 |
| BSCOSE as base | 0.146 | 1995 K | 1341 lm | 81.3 |
| layer/ Example 1 | | | | |
| YAG as base layer/ | 0.071 | 1945 K | 1408 lm | 81.3 |
| Example 2 | | | | |

The LT 18 W low-pressure gas-discharge lamp in the warm-white comfort light colour has the highest circadian effect factor of the four low-pressure gas-discharge lamps. Apart from the mercury lines, the spectrum of this low-pressure gas-discharge lamp, as shown in FIG. 3, also has a blue content from phosphor emission, which thus causes the highest circadian factor compared with the other three low-pressure gas-discharge lamps.

The LT 18 W low-pressure gas-discharge lamp in the red light colour, shown in FIG. 4, has no blue content from phosphor emission on the phosphor side. The blue content of this low-pressure gas-discharge lamp is caused solely by the emission of the visible lines from the mercury discharge. This low-pressure gas-discharge lamp consequently has a lower circadian factor than the low-pressure gas-discharge lamp in the warm-white comfort light colour, but is unsuitable for visual tasks owing to the very low colour reproduction index.

In the low-pressure gas-discharge lamps according to the invention from Examples 1 and 2, the spectra of which are shown in FIG. 5 and FIG. 6, excitation of the phosphor in the base layer takes place through the mercury lines at 405 nm and 436 nm and emission in the visible region from yellow to red-orange.

The low-pressure gas-discharge lamps according to the invention from Examples 1 and 2 are highly suitable for visual tasks. The low-pressure gas-discharge lamp in Example 1, which has the phosphor BSCOSE (F612) in the base layer, has, owing to the closer proximity to the standard illuminant on a black body, a better visual function than the low-pressure gas-discharge lamp from Example 2 comprising the phosphor YAG, which, however, has a lower circadian effect factor and thus increases melatonin secretion.

In combination with light sources for melatonin suppression, the low-pressure gas-discharge lamp according to the invention with its warm light is therefore particularly suitable for simulation of the quasi-circadian rhythm in an individual in the absence of external conditions, such as sunlight. At the same time, the novel low-pressure gas-discharge lamp meets all necessary requirements of a light source for illumination tasks through good colour reproduction and high energy efficiency and is thus also suitable for general lighting.

1. Low-pressure gas-discharge lamp for influencing the endogenous melatonin balance, consisting of a discharge tube made from glass which is multicoated on the inside with phosphor and has at both ends of the discharge tube electrodes for the supply of energy and is filled with a noble gas or noble-gas mixture and mercury, characterised in that the phosphor layers are applied one after the other, where the first phosphor layer (2) located on the glass surface (1) consists of phosphor which is excited both by ultraviolet mercury radiation between 180 nm and 400 nm and also by the visible radiation between 400 nm and 550 nm emitted by the mercury discharge and the second or further phosphor layers (3), where visible light having emission maxima in the range between 500 nm and 650 nm is generated.

2. Low-pressure gas-discharge lamp for influencing the endogenous melatonin balance, characterised in that the layer thickness of the first phosphor layer which serves as base layer is between 0.2 mg/cm² and 2.0 mg/cm², preferably 1.25 mg/cm², and the layer thickness of the second phosphor layer which serves as top layer is between 1.0 mg/cm² and 6.0 mg/cm², preferably 3.25 mg/cm².

3. Low-pressure gas-discharge lamp according to claim 1, characterised in that the first phosphor layer applied directly to the glass surface consists of a phosphor or phosphor mixture from the group of the silicates or aluminates and is preferably doped with europium or cerium.

4. Low-pressure gas-discharge lamp according to claim 1, characterised in that the phosphor belongs to the group of the alkaline-earth metal orthosilicates and/or alkaline-earth metal oxyorthosilicates, activated by divalent europium, and the ions may contain further rare-earth metals as well as manganese, zinc and magnesium.

5. Low-pressure gas-discharge lamp according to claim 1, characterised in that the phosphor consists of an Eu-activated alkaline-earth metal orthosilicate having the formula (Ba, Sr, Ca)₂SiO₄:Eu (BOSE) or an Eu-activated alkaline-earth metal oxyorthosilicate having the formula (Ba, Sr, Ca)₃SiO₅:Eu (SOOS) or is an aluminate from the group of the garnets having the formula Y₃Al₅O₁₂:Eu (YAG).

6. Low-pressure gas-discharge lamp according to claim 1, characterised in that the phosphor in the first phosphor layer has an emission maximum in the spectral region between 560 nm and 620 nm.

7. Low-pressure gas-discharge lamp according to claim 1, characterised in that the second phosphor layer consists of one or more narrowband-emitting phosphors which emit in blue/turquoise at an emission maximum between 440 nm and 500 nm and/or in green at an emission maximum between 535 nm to 555 nm and/or in red at an emission maximum between 605 nm to 630 nm.

8. Low-pressure gas-discharge lamp according to claim 1, characterised in that the red-emitting phosphor is an yttrium oxide:Eu and/or yttrium vanadate:Eu and/or magnesium fluorogermanate:Mn, the green-emitting phosphor is a lanthanum phosphate:Ce,Tb and/or magnesium aluminate:Ce,Tb, and the blue/turquoise-emitting phosphor is a barium magnesium aluminate:Eu and/or strontium calcium barium phosphate:Eu and/or strontium aluminate:Eu and/or strontium chlorophosphate:Eu.

9. Low-pressure gas-discharge lamp according to claim 1, characterised in that the proportion of blue-emitting phosphor in the mixture is between 0% and 10%.

10. Low-pressure gas-discharge lamp according to claim 1, characterised in that the discharge tube is shaped by folding, deformation, welding or joining, in which the outer dimensions of the discharge vessel are only a fraction of the extended length of the discharge vessel.

11. Low-pressure gas-discharge lamp according to claim 1, characterised in that the discharge vessel is in the shape of a double helix or is made from U shapes connected together and from short tube sections joined together via connecting channels.
